(19) United States
(12) Patent Application Publication
(10) Pub. No.: US 2010/0312610 A1
(43) Pub. Date: Dec. 9, 2010

(54) ARCHITECTURE PLAN MARKET

(75) Inventor: Mark Johnson, Houston, TX (US)

Correspondence Address: HAYNES AND BOONE, LLP;IP Section, 2323 Victory Avenue, Suite 700, Dallas, TX, 75219, US

(73) Assignee: HOMETTA, INC., Houston, TX (US)

(21) Appl. No.: 12/481,342

(22) Filed: Jun. 9, 2009

(51) Int. Cl. G06Q 30/00; G06Q 50/00; G06Q 20/00; G06Q 10/00

(52) U.S. Cl. 705/10; 705/27; 705/14.7

(57) ABSTRACT

A computer program product that executes a method for providing an architecture plan market. The method may include receiving an architecture plan set from a designer, and storing the architecture plan set in an electronic storage medium. Further, the method may include allowing one or more subscribers to electronically view the architecture plan set, and facilitating purchases of the architecture plan set by one or more subscribers. The method may also include paying a plan royalty to the designer in connection with a purchases of the architecture plan set by the one or more subscribers, and paying an additional royalty, wherein the additional royalty comprises a portion of a revenue streams received by the architecture plan market, wherein the revenue stream does not include revenue generated by the purchase of the architecture plan set.

### BACKGROUND

Traditionally, the concept of a market is any system that allows buyers and sellers to exchange any goods, services and information. A transaction may involve the exchange of goods or services for money. Traditionally, markets existed as physical spaces where parties would meet to conduct transactions. However, with the advent of the Internet, many traditional markets were replicated using website technology. These new web-based marketplaces made transactions accessible to the masses via a virtual platform, and in many cases, made such transactions more affordable. There is a growing demand for architectural design plans. However, traditional methods of sharing architectural design plans are not easily accessible and may be too expensive to promote mass appeal. An architecture plan market can facilitate making architecture design accessible and affordable to designers, builders and others.

### SUMMARY

Embodiments of the disclosure may provide a computer program product that includes a computer-readable medium, the medium having stored thereon a sequence of instructions which, when executed by a processor, causes the processor to execute a method for providing an architecture plan market. The method may include receiving an architecture plan set from a designer, and storing the architecture plan set in an electronic storage medium. Further, the method may include allowing the one or more subscribers to electronically view the architecture plan set, and facilitating purchases of the architecture plan set by the one or more subscribers. The method may also include paying a plan royalty to the designer in connection with a purchase of the architecture plan set by one or more subscribers, and paying an additional royalty, wherein the additional royalty includes a portion of one or more revenue streams received by the architecture plan market, wherein the revenue stream does not include revenue generated by the purchase of the architecture plan set.

Embodiments of the present disclosure may further provide a system for providing an architecture plan market, that may include means for receiving an architecture plan set from a designer, and means for storing the architecture plan set in an electronic storage medium. Further, the system may include means for allowing one or more subscribers to electronically view the architecture plan set via a website, and means for facilitating purchases of the architecture plan set by one or more subscribers. In addition, the system may include means for paying a plan royalty to the designer in connection with a purchase of the architecture plan set, and means for paying an additional royalty, wherein the additional royalty comprises a portion of one or more revenue streams received by the architecture plan market, wherein the revenue stream does not include revenue generated by the purchase of the architecture plan set.

Embodiments of the present disclosure may further provide a system for providing an architecture plan market, which may include a designer module configured to receive an architecture plan set from a designer and store the architecture plan set in a database. The system may also include a subscriber module configured to allow one or more subscribers to electronically view the architecture plan set, and facilitate purchases of the architecture plan set by one or more subscribers. Further, the system may include a royalty module configured to pay a plan royalty and an additional royalty to the designer, wherein the additional royalty comprises a portion of one or more revenue streams received by the architecture plan market, wherein the revenue stream does not include revenue generated by the purchase of the architecture plan set.

### DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of a system according to one or more aspects of the present disclosure.

FIG. 2 is a flowchart of a method according to one or more aspects of the present disclosure.

FIG. 3 is a schematic view of a website according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In describing selected embodiments, various objects or components may be implemented as computing modules. These modules may be general-purpose, or they may have dedicated functions such as memory management, program flow, instruction processing, object storage, etc. The modules can be implemented in any way known in the art. For example, in one embodiment a module is implemented in a hardware circuit including custom VLSI circuits or gate arrays, off-the-shelf semiconductors such as logic chips, transistors, or other discrete components. One or more of the modules may also be implemented in programmable hardware devices such as field programmable gate arrays, programmable array logic, programmable logic devices or the like.

In an exemplary embodiment, one or more of the modules are implemented in software for execution by various types of processors. An identified module of executable code may, for instance, may include one or more physical or logical blocks of computer instructions that may, for instance, be organized as an object, procedure, or function. Further, the executables of an identified module need not be physically located together, but may include disparate instructions stored in different locations that, when joined logically together, include the module and achieve the stated purpose for the module. A “module” of executable code could be a single instruction, or many instructions, and may be distributed over several different code segments, among different programs, and across several memory devices. Similarly, operational data may be identified and illustrated in association with one or more modules, and may be embodied in any suitable form and organized within any suitable type of data structure. The operational data may be collected as a single data set, or may be distributed over different locations including over different storage devices, and may exist, at least partially, as electronic signals on a system or network.

In some embodiments, higher-level components may be used as modules. For example, one module may include an entire computer acting as a network node. Another module may include of an off-the-shelf or custom program, such as a database management system. These higher-level modules may be decomposable into smaller hardware or software modules corresponding to different parts of a software program and identifiable chips (such as memory chips, ASICs, or a CPU) within a computer.

One type of module is a “network.” A network module defines a communications path between endpoints and may include an arbitrary amount of intermediate modules. A network module may encompass various pieces of hardware, such as cables, routers, and modems, as well the software necessary to use that hardware. Another network module may encompass system calls or device-specific mechanisms such as shared memory, pipes, or system messaging services. A third network module may use calling conventions within a computing module, such as a computer language or execution environment. Information transmitted using the network module may be carried upon an underlying protocol, such as HTTP, BXXP, or SMTP, or it may define its own transport over TCP/IP, IPX/SPX, Token Ring, ATM, etc. To assure proper transmission, both the underlying protocol as well as the format protocol may split the information into separate pieces, wrap the information in an envelope, or both. Further, a network module may transform the data through the use of one or more computing modules.

What constitutes a “party” or an “entity” may vary between embodiments. In one embodiment, the parties may be people interacting with the system. In an exemplary embodiment, the parties may be different systems that need to interact in an arm's-length transaction. A third embodiment may use computing modules as parties. A fourth embodiment may use more than one type of entity in the same transaction, such as a combination of the above noted exemplary entities.

A computer system typically includes at least hardware capable of executing machine readable instructions, as well as the software for executing acts (typically machine-readable instructions) that produce a desired result. In addition, a computer system may include hybrids of hardware and software, as well as computer sub-systems.

Hardware generally includes at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

Combinations of software and hardware could also be used for providing enhanced functionality and performance for certain embodiments of the disclosed invention. One example is to directly manufacture software functions into a silicon chip. Accordingly, it should be understood that combinations of hardware and software are also included within the definition of a computer system and are thus envisioned by the invention as possible equivalent structures and equivalent methods.

Computer-readable mediums include passive data storage, such as a random access memory (RAM) as well as semi-permanent data storage such as a compact disk read only memory (CD-ROM). In addition, an embodiment of the invention may be embodied in the RAM of a computer to transform a standard computer into a new specific computing machine.

Data structures are defined organizations of data that may enable an embodiment of the invention. For example, a data structure may provide an organization of data, or an organization of executable code. Data signals could be carried across transmission mediums and store and transport various data structures, and, thus, may be used to transport an embodiment of the invention.

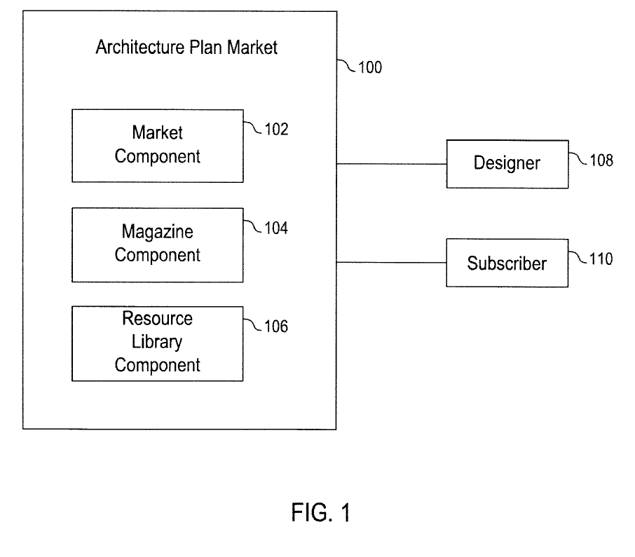

Referring to FIG. 1, an architecture plan market 100 may include several components. These components may include without limitation: a market component 102, a magazine component 104, and a resource library component 106. The architecture plan market 100 may facilitate interaction between two or more parties, which may include designers 108 and subscribers 110.

A designer 108 may be an entity that includes one or more individual designers 108 or one or more design firms. A “member designer” may be a designer 108 that has registered with the architecture plan market 100, and a “potential designer” may include a designer 108 that has not registered with the architecture plan market 100. In an exemplary embodiment, a subscriber 110 may be an entity that accesses the market component 102 with the intent of browsing or purchasing architecture plans. In another exemplary embodiment, a subscriber 110 may be an entity that accesses the magazine component 104 or resource library component 106 in order to receive content and other information disseminated by the architecture plan market 100.

One or more subscribers 110 may be grouped into a subscription level. In an exemplary embodiment, the subscription level may be associated with access to certain portions of the market component 102, the magazine component 104, and the resource library component 106. For example, subscription levels may include “free” subscriber, “basic” subscriber, and “premium” subscriber. The foregoing classifications are merely representative, and other classifications are also within the scope of the present disclosure.

Further, each of the foregoing classifications may be associated with a certain payment. In an exemplary embodiment, the payment may include a monthly payment. In another exemplary embodiment, the payment may be include a yearly payment. Other payment terms are also within the scope of the present disclosure.

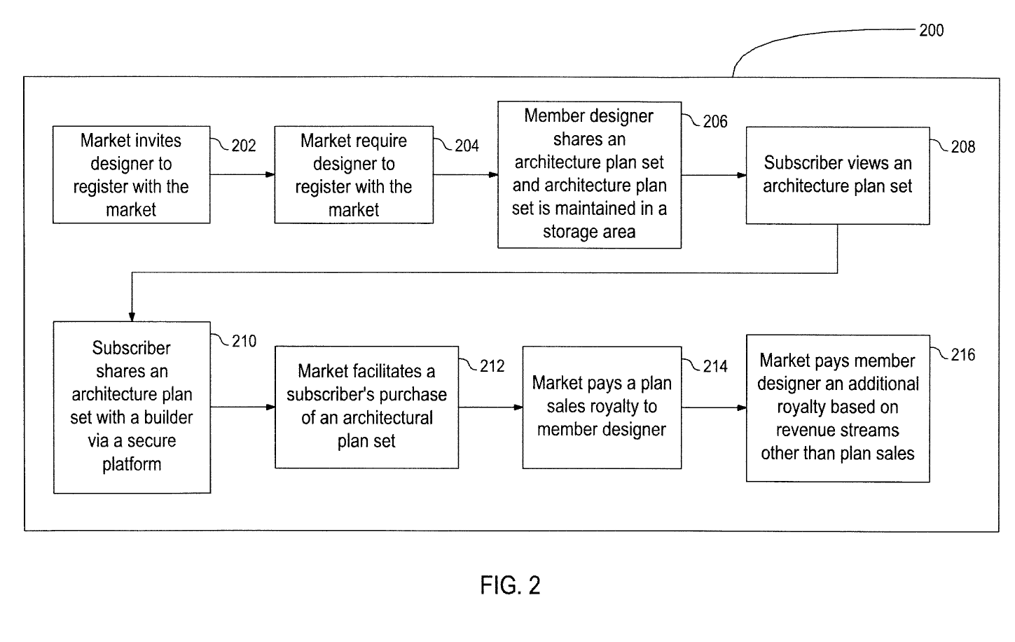

The architecture plan market 100 may facilitate transactions between designers 108 and subscribers 110. FIG. 2 shows a portion of an exemplary method 200 that may facilitate a transaction between a designer 108 and a subscriber 110. Method 200 is described in more detail below.

At step 202, a designer 108 may be invited to register with the architecture plan market 100. At step 204, the designer 108 may register with the architecture plan market 100. The member designer 108 may share an architecture plan set with one or more subscribers at step 206. In one exemplary embodiment, an architecture plan set may include a full set of renderings, design documents, and construction documents. An architecture plan set may be an exclusive architecture plan set, in which case, the architecture plan set is not sold to any other subscribers 110 after it has been purchased by a subscriber. After the member designer 108 has provided the architecture plan market 100 with the architecture plan set, the architecture plan market 100 may maintain the architecture plan set in a storage medium. The storage medium may be a database in one exemplary embodiment. In another exemplary embodiment, the storage medium may be a networked drive, a hard drive, or some other computer readable medium. Other storage mechanisms may also serve as storage mediums within the scope of the present disclosure.

A subscriber 110 may view the architecture plan set at step 208, and share the architecture plan set and other construction documents with a builder via a secure platform at step 210. If the subscriber 110 decides to purchase the architecture plan set, then the architecture plan market 100 may facilitate the transaction and receive the funds from the subscriber 110 at step 212. The architecture plan market 100 may pay a percentage of the price of the architecture plan set to the designer 108 as a plan royalty at step 214. Further, the architecture plan market 100 may pay a portion of additional revenue streams received by the architecture plan market 100 as an additional royalty at step 216. Additional royalties may be based on advertising revenues received by the architecture plan market 100, as well as other revenues as described above.

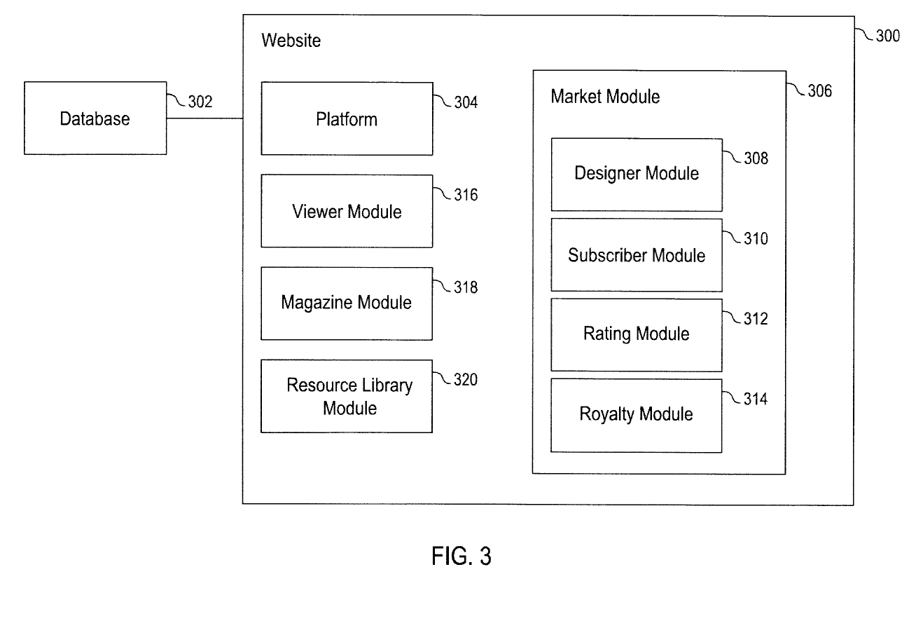

Referring to FIG. 3, according to one exemplary embodiment, the architecture plan market 100 may be implemented as a website 300 that may include one or more web pages that retrieve information stored in a database 302. The database 302 may be implemented using any kind of technology, including, without limitation, Microsoft SQL Server, MySQL, and IBM DB2, etc. An exemplary website 300 may include one or more modules that implement the functionality of the market component 102, the magazine component 104, and the resource component 106.

Further, an exemplary embodiment of a website 300 may include a platform module 304, which may provide an interface between one or more subscribers and the website 300. The platform module 304 may be implemented using any technology known in the art. For example, the platform module 304 may be implemented using programming languages, such as HTML, ASP, ASP.NET, PERL, etc. to provide information to a user. The platform module 304 may enable designers 108 and subscriber 110 to interface with the architecture plan market 100 as well as other parties.

Certain portions of the website 300 may be access-restricted. For example, a subscriber 110 may be required to pay a fee in order to gain access to certain portions of the website 300. Other access restriction systems are also within the contemplated scope of the present disclosure. In one exemplary embodiment, the designer module 308 may regulate a designer's 108 access to the website 300. For example, a potential designer 108 may not be able to create a website 300 account unless a member designer 108 has invited the potential designer 108 to join the website 300. In another exemplary embodiment, the number of member designers 108 registered with the website 300 may be limited to a predetermined number. Other embodiments may include an unlimited number of member designers 108.

An exemplary embodiment of the website 300 may include a market module 306, a magazine module 318, and a resource library module 320. The market module 306 may implement the functionality of the market component 102 of an architecture plan market 100. An exemplary market module 306 may include a designer module 308, a subscriber module 310, a rating module 312, and a royalty module 314.

The designer module 308 may implement functionality related to designers 108. An exemplary embodiment of the designer module 308 may enable designers 108 to share architecture plan sets with subscribers 110. According to one exemplary embodiment, the architecture plan market 100 and a designer 108 may contractually agree to restrict a designer 108 from selling or advertising an architecture plan set outside of the website 300. The designer module 308 may facilitate sharing of an architecture plan by receiving an architecture plan set uploaded by a designer 108, and storing the architecture plan set in the database 302.

The designer module 308 may further restrict the behavior of member designers 108. For example, in one exemplary embodiment, a member designer 108 may only submit and/or share architecture plan sets with subscribers 110 after the architecture plan sets have been approved. An approval process may include obtaining the approval of one or more other member designers 108. In other exemplary embodiments, there may be different restrictions, or no restrictions at all, with respect to the sharing of architecture plan sets.

The designer module 308 may further provide for one or more web pages that may be customized by a designer 108. A designer 108 may customize one or more web pages to include information about the designer 108 and the designer's 108 architecture plan sets. The designer 108 may also include artist renderings of architecture plan sets, designer 108 resumes, designer 108 philosophies, designer 108 portfolios, one or more web links to the designer's 108 personal website, and any other information that a designer 108 wants.

The subscriber module 310 may implement functionality available to a subscriber 110. According to one exemplary embodiment, subscriber 110 functionality may include the ability to view architecture plan sets using a viewer module 316. The viewer module 316 may allow a subscriber 110 to view architecture plan sets and share the architecture plan sets with one or more builders via a secure platform 304. Further, the viewer module 316 may also enable viewing and sharing of other construction-related documents with other entities. Access to construction-related documents other than the architecture plan sets may require additional fees. Sharing architecture plan sets and other documents with a builder enables a subscriber 110 to obtain bids from a builder before making the decision to purchase an architecture plan set.

The secure platform 304 may implement technology that is intended to prevent abuse within the architecture plan market 100. For example, according to one exemplary embodiment, the secure platform 304 may include copyright-protection technology that prevents a subscriber 110 from copying the architecture plan set when viewing the architecture plan set via the viewer module 316. Also, the secure platform 304 may incorporate a digital watermark into the architecture plan set, so that the digital watermark identifies an architecture plan set as belonging to the architecture plan market 100. In another exemplary embodiment, the secure platform 304 may monitor the number of architecture plan sets that may be viewed by a subscriber 110 and/or shared with a builder, and may limit a subscriber 110 to viewing an architecture plan set a predetermined number of times. In yet another exemplary embodiment, the secure platform 304 may place a time limit on how long an architecture plan set may be viewed. The foregoing are just a couple of exemplary embodiments of how the secure platform 304 may prevent abuse within the architecture plan market 100. However, other embodiments are also within the scope of the present disclosure.

One exemplary embodiment of the viewer module 316 may be a web-browser plug-in. Alternatively, another exemplary embodiment of the viewer module 316 may be implemented using a stand-alone computer application. The viewer module 316 may offer the subscriber 110 a secure platform for interfacing with the website 300. The security utilized by the viewer module 316 may include password protection, Secured Socket Layer (SSL) encryption, or any other type of encryption or security technology known in the art.

The subscriber module 310 may also implement a builder search engine. A subscriber 110 may use the builder search engine to find a builder. The builder search engine may allow the subscriber 110 to enter one or more limiting factors in order to narrow a search. For example, a subscriber 110 might enter its zip code in order to find a local builder. Other limiting factors may include qualifications, certifications, or any other characteristic that may assist the user in identifying a builder.

An exemplary embodiment of the market module 306 may include a rating module 312. One exemplary embodiment of the rating module 312 may allow subscribers 110 and/or designers 108 to submit textual comments regarding an architecture plan set. Another exemplary embodiment of a rating module 312 may allow subscribers 110 and/or designers 108 to rate an architecture plan set based on a numerical scale. Other rating systems that allow subscribers 110 and/or designers 108 to submit feedback regarding an architecture plan set are also contemplated to be within the scope of the current disclosure. According to one embodiment, feedback obtained via the rating module 312 may be used determine which architecture plan sets may be shared with subscribers 110.

The royalty module 314 may include functionality that tracks sales of architecture plan sets, and authorizes a designer 108 to receive plan royalties based on sales of its architecture plan sets. For example, according to an exemplary embodiment, a designer 108 may receive a portion of the list price of an architecture plan set as a royalty each time one of its architecture plan sets is sold to a subscriber. In another exemplary embodiment, the royalty module 314 may track the advertising fees paid by one or more advertisers, and authorize a designer 108 to receive advertising royalties based on such advertising fees. Other royalty-sharing plans are also within the scope of the present disclosure.

In an exemplary embodiment, the architecture plan marketplace 100 may pay one or more royalties to a designer 108, wherein the royalties are taken from a portion of one or more revenue streams. According to one exemplary embodiment, a designer 108 may receive subscription royalties based on subscription revenue received by the architecture plan marketplace 100 from one or more subscribers 110. That is, in addition to plan royalties related to architecture plan marketplace 100 sales, a designer 108 may receive a portion of revenue that the architecture plan marketplace 100 receives from fees paid by subscribers 110. According to another exemplary embodiment, designers 108 may pay the architecture plan marketplace 100 a referral fee if a subscriber 110 discovers the designer 108 via the website 300. For example, if a subscriber 110 wants the designer 108 to customize an architecture plan set, the designer may be required to pay a referral fee to the architecture plan marketplace 100. The payment of the referral fee may be contingent on whether the subscriber 110 executes a full-service contract with the designer 108.

In yet another exemplary embodiment, the architecture plan marketplace 100 may pay a designer 108 a portion of advertising revenue that the architecture plan marketplace 100 receives from advertisers. For example, an advertiser may pay to have a banner ad or some other form of advertisement appear on the website 300. The architecture plan marketplace 100 may vary the fee charged to the advertiser using some criteria, such as where the advertisement appears, when the advertisement appears, a per-click amount, or any other criteria known in the art. A portion of the fees may then be shared with one or more designers 108.

In another exemplary embodiment, the architecture plan marketplace 100 may pay a designer 108 a royalty that includes a portion of all architecture plan marketplace 100 revenue streams, including without limitation, the revenue streams described above. It should be understood that the foregoing description of royalties and revenue streams is not meant to be exclusive, and that other royalties and revenue streams are also within the scope of the present disclosure.

According to one exemplary embodiment, after a designer 108 sells an architecture plan set, the designer 108 may retain all of the intellectual property rights it may have in its architecture plan sets. In another exemplary embodiment, the designer 108 may agree to share or assign certain intellectual property rights in an architecture plan set once it has been sold. For example, the designer 108 may agree to share certain patent rights or copyright rights related to an architecture plan set with a subscriber after the subscriber purchases one if its architecture plan sets. According to yet another exemplary embodiment, a designer 108 may choose to offer subscribers 110 additional services and modifications according to the designer's 108 own terms. For example, the designer 108 may offer consulting services or other design services.

The magazine module 318, according to one exemplary embodiment, may implement the functionality of the magazine component 104. The magazine module 318 may be configured to provide subscribers 110 with editorial content related to designers 108, such as reviews of plan sets. The magazine module 318 may also be configured to provide subscribers 110 with promotional content related to designers 108. Such promotional content may include “spotlight” content that highlights designer 108 achievements. Other types of content are also within the scope of the present disclosure. According to one exemplary embodiment, certain portions of the magazine module 318 may be access-restricted such that only certain subscribers 110 and/or designers 108 may access such portions. For example, portions of the magazine module 318 might only be available to entities that have paid a certain fee to the architecture plan marketplace 100.

The magazine module 318 may provide a webmaster or some other entity, such as a designer 108 and/or a subscriber 110, with the ability to submit and edit content. The content may include, without limitation, written, audio and/or visual materials, such as instructional videos, podcasts, interview videos, interview transcripts, construction site tour videos, and live text and/or video chats. According to one exemplary embodiment, the architecture plan marketplace 100 may require one or more designers 108 to submit new content from time to time. This may facilitate the availability of fresh content that may interest subscribers 110 and/or designers 108. The content may be available to subscribers 110 and/or designers 108 for free. Furthermore, certain content may be designated as premium content that requires subscribers 110 and/or designers 108 to pay an access fee.

In one exemplary embodiment, a designer 108 that authors premium content may receive a portion of the subscription fees associated with such premium content. The magazine module 318 may facilitate distribution of the content via any distribution means known in the art. For example, according to one exemplary embodiment, the magazine module 318 may deliver content via email, or some other type of delivery technology, such as Really Simple Syndication (“RSS”) technology. In another exemplary embodiment, content may be streamed to a receiving entity via video streaming technologies.

The resource library module 320, according to one exemplary embodiment, may include content that includes information that may assist subscribers 110 during the bidding and construction process. Such content may include educational resources about the house construction process, new construction materials, sustainable construction design, and green-construction certification programs. Other content is also within the scope of the present disclosure. The content may be contributed by designers 108 and/or subscribers 110. Alternatively, the content may be provided by a webmaster or some other entity. According to one exemplary embodiment, certain portions of the resource library module 320 may be access-restricted such that only certain subscribers 110 and/or designers 108 may access such portions. Access to such portions may be conditioned upon payment of a fee, for instance. Resource library content may also be delivered using any technology that may be used to deliver magazine content, as discussed above.

Although the present disclosure has described embodiments relating to specific networking environments, it is understood that the apparatus, systems and methods described herein could applied to other environments. For example, according to another exemplary embodiment, an architecture plan market 100 may be implemented in a virtual environment, such as a virtual world. Alternatively, the described apparatus, systems and methods may be embodied as a physical embodiment. It is understood that several modifications, changes and substitutions are intended in the foregoing disclosure and in some instances some features of the embodiments will be employed without a corresponding use of other features. Accordingly, it is appropriate that the appended claims be construed broadly and in a manner consistent with the scope of the embodiments described herein.

Any spatial references used herein, such as, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above. Additionally, in several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A computer program product that includes a computer-readable medium, the medium having stored thereon a sequence of instructions which, when executed by a processor, causes the processor to execute a method for providing an architecture plan market, said method comprising:
receiving an architecture plan set from a designer;
storing the architecture plan set in an electronic storage medium;
allowing one or more subscribers to electronically view the architecture plan set;
facilitating purchases of the architecture plan set by the one or more subscribers;
paying a plan royalty to the designer in connection with a purchase of the architecture plan set by one or more subscribers; and
paying an additional royalty comprising a portion of a revenue stream received by the architecture plan market, wherein the revenue stream does not include revenue generated by the purchase of the architecture plan set.

2. The method of claim 1, wherein the additional royalty comprises a portion of all revenue streams received by the architecture plan marketplace.

3. The method of claim 1, wherein the additional royalty comprises a subscription royalty that comprises a portion of a subscription fee paid by the one or more subscribers.

4. The method of claim 1, wherein the additional royalty comprises an advertisement royalty that comprises a portion of an advertisement fee paid to the architecture plan marketplace by one or more advertisers.

5. The method of claim 1, further comprising paying a referral fee from the designer to the architecture plan marketplace in connection with a purchases of the architecture plan set by one or more subscribers.

6. The method of claim 1, further comprising providing one or more subscribers with content related to the designer.

7. The method of claim 1, further comprising enabling a user to view the architecture plan set via a secure platform.

8. A system for providing an architecture plan market, comprising:
means for receiving an architecture plan set from a designer;
means for storing the architecture plan set in an electronic storage medium;
means for allowing one or more subscribers to electronically view the architecture plan set via a website;
means for facilitating purchases of the architecture plan set by the one or more subscribers;
means for paying a plan royalty to the designer in connection with a purchases of the architecture plan set; and
means for paying an additional royalty, wherein the additional royalty comprises a portion of a revenue stream received by the architecture plan market, wherein the revenue stream does not include revenue generated by the purchase of the architecture plan set.

9. The system of claim 8, wherein the additional royalty comprises a portion of all revenue streams received by the architecture plan marketplace.

10. The system of claim 8, wherein the additional royalty comprises a subscription royalty that comprises a portion of a subscription fee paid by the one or more subscribers.

11. The system of claim 8, wherein the additional royalty comprises an advertisement royalty that comprises a portion of an advertisement fee paid to the architecture plan marketplace by one or more advertisers.

12. The system of claim 8, further comprising paying a referral fee from the designer to the architecture plan marketplace in connection with a purchases of the architecture plan set by one or more subscribers.

13. The system of claim 8, further comprising means for providing one or more subscribers with content related to the designer.

14. The system of claim 8, further comprising means for enabling a user to view the architecture plan set via a secure platform.

15. A system for providing an architecture plan market, comprising:
a designer module configured to receive an architecture plan set from a designer and store the architecture plan set in a database;
a subscriber module configured to allow one or more subscribers to electronically view the architecture plan set, and facilitate purchases of the architecture plan set by the one or more subscribers; and
a royalty module configured to pay a plan royalty and an additional royalty to the designer, wherein the additional royalty comprises a portion of a revenue stream received by the architecture plan market, wherein the revenue stream does not include revenue generated by the purchase of the architecture plan set.

16. The system of claim 15, wherein the additional royalty comprises a portion of all revenue streams received by the architecture plan marketplace.

17. The system of claim 15, wherein the additional royalty comprises a subscription royalty that comprises a portion of a subscription fee paid by the one or more subscribers.

18. The system of claim 15, wherein the additional royalty comprises an advertisement royalty that comprises a portion of an advertisement fee paid to the architecture plan marketplace by one or more advertisers.

19. The system of claim 15, further comprising a viewer module configured to enable a user to view the architecture plan set via a secure platform.

20. The system of claim 15 further comprising a rating module configured enable subscribers to rate the architecture plan set.
